(19) United States
(12) Patent Application Publication
(10) Pub. No.: US 2016/0076724 A1
(43) Pub. Date: Mar. 17, 2016

(54) LIGHT SOURCE SUPPORT WITH INTEGRAL CONNECTOR

(71) Applicant: Valeo Vision, Bobigny Cedex (FR)

(72) Inventors: Hui Jin, Paris (FR); Christophe Dubosc, Villemomble (FR); David Hue, Butry Sur Oise (FR); Maxime Briand, Change (FR); Zdravko Zojceski, Courbevoie (FR)

(21) Appl. No.: 14/853,243

(22) Filed: Sep. 14, 2015

(30) Foreign Application Priority Data
Sep. 15, 2014 (FR) 1458669

(51) Int. Cl. F21S 8/10; F21V 23/06

(52) U.S. Cl. CPC F21S 48/212; F21S 48/217; F21S 48/2206; F21V 23/06; F21Y 2101/02

(57) ABSTRACT

A support for light source(s) for a light module, notably for a motor vehicle, comprising a substrate with at least one zone for receiving a light source, and electrical tracks deposited on the substrate to the zone or zones for receiving light source(s), the tracks being intended to power the light source or sources. The substrate comprises at least one protruding portion of a piece with the rest of the substrate and on which the electrical tracks extend from the reception zone or zones, the portion or portions being suitable for cooperating with an electrical connector, respectively.

### CROSS-REFERENCE TO RELATED APPLICATIONS

This application claims priority to the French application 1458669 filed on Sep. 15, 2014, which application is incorporated herein by reference and made a part hereof.

### BACKGROUND OF THE INVENTION

1. Field of the Invention

The invention deals with the field of lighting and/or light indication, notably for a motor vehicle. More specifically, the invention deals with the field of the lighting and light indication by means of light-emitting diodes (LEDs) and organic light-emitting diodes (OLEDs).

2. Description of the Related Art

The patent document US 2005/0243558 A1, which is now issued as U.S. Pat. No. 7,044,620, discloses an LED diode support for an indication module of the motor vehicle rear light type. It consists of a plate with printed circuit and comprising a series of orifices through which are inserted LED diodes of the inverted mounting type. These LEDs comprise optical parts in the form of domes, these domes being visible from the side of the front face. The LEDs comprise fixing and electrical connection tabs soldered with electrical tracks on the rear face of the plate. This mounting provides an aesthetic support when observed from a viewpoint situated to the side of the front face, the electrical connections being exclusively on the rear face. Furthermore, it allows a heat sink to be placed on the rear face of the base of the LED. The electrical tracks extend to an edge of the plate in order to be able to ensure a connection with a power supply. The electrical tracks are terminated by typical circular solder link zones. Now, the soldering operations require particular care and constitute an additional step in the assembly of the support.

The published patent document FR 2 995 657 A1 discloses a light source with diodes of the OLED type, comprising a support with cavities filled by the diodes. The support comprises, on one of its faces, electrodes or electrical tracks intended to electrically contact the diodes for their electrical power supply. The diodes comprise a stacking of organic layers and a transparent substrate arranged on the stacking concerned. The substrate has a surface area of greater size than that of the organic layers in order to extend beyond the corresponding cavity and thus come into contact with the electrical tracks, around the cavity. The support is produced by the injection of insulating material such as thermoplastic or thermosetting plastic. It can be plane, with a dip or even of more complex form. The electrical tracks are limited to ensuring the powering of the diodes. This teaching does not address the issue of the connection to an electrical power supply.

### SUMMARY OF THE INVENTION

The aim of the invention is to propose a support for light source(s) for a light module of which the electrical connection is simplified.

The subject of the invention is a support for light source(s) for a light module, notably for a motor vehicle, comprising: a substrate with at least one zone for receiving a light source; electrical tracks deposited on the substrate to the zone or zones for receiving light source(s), the tracks being intended to power the light source or sources; noteworthy in that the substrate comprises at least one protruding portion of a piece with the rest of the substrate and on which the electrical tracks extend from the reception zone or zones, the portion or portions being connection portions suitable for cooperating with an electrical connector, respectively.

Some of the electrical tracks can extend over at least a part of a front surface of the support. The front surface is a surface of the support which, when the support is mounted on a vehicle, is visible from the outside of the vehicle.

The tracks advantageously form a network of tracks, these tracks being able to be of the same width.

“Of a piece” should be understood to mean that the connection portion or portions are produced in the same material as the rest of the substrate and that their link with the rest of the substrate is produced when they are formed together, notably by molding.

According to an advantageous embodiment of the invention, the substrate is a rigid molded part having a three-dimensional form. Advantageously, the substrate consists essentially of a wall of an average thickness of between 0.5 and 3 mm.

According to an advantageous embodiment of the invention, the substrate is made of a thermoplastic material doped with metal particles so as to allow the bonding of the electrical tracks made of metal material.

Advantageously, the substrate can be produced in a thermoplastic material, the electrical tracks being printed on the substrate itself. The printing can be of the inkjet type with an ink that includes metal particles. As a variant, the tracks can be produced by printing or screen printing on a film of polyethylene terephthalate (PET) or of polyethylene naphthalate (PEN), the film being deposited on the substrate, for example by thermodeformation. Also as a variant, the tracks can also be produced by a two-step molding of the substrate, also called “two shot molding”. This is an injection molding process using two different resins in which only one of the two resins can be metallized. The substrate is then subjected to an autocatalytic deposition process in which butadiene is used to chemically roughen the surface and allow for the adhesion of a primary layer of copper.

According to an advantageous embodiment of the invention, least one of the connection portions has the form of a tongue with two opposing main faces, the electrical tracks extending preferentially on the two faces.

According to an advantageous embodiment of the invention, at least one of the connection portions in the form of a tongue has, on a distal zone intended to penetrate into the connector, a reduced thickness relative to the thickness of a proximal zone of the portion, the thickness of the distal zone being preferentially less than 50% of the thickness of the proximal zone. The distal and proximal zones extend from the substrate. More specifically, proximal zone should be understood to mean a zone of the connection portion which is closer to the support than a distal zone of the portion, the distal zone then being further away from the support. Advantageously, the transition between the two distal and proximal zones forms a dip. The dip is present on both main faces of the connection portion.

Advantageously, the electrical tracks extend essentially parallel to one another and on the main axis of the connection portion. In this case, the main axis of the connection portion corresponds to the optical and longitudinal axis of the module. The electrical tracks can extend essentially to the distal edge of the connection portion, so as to extend over all of the distal zone.

According to an advantageous embodiment of the invention, at least one of the connection portions comprises a notch serving as poka-yoke with the corresponding connector. The notch can be provided on just one of the two sides of the connection portion, the notch allowing a corresponding edge of the connector to advance until the connector is in the position of engagement on the connection portion.

According to an advantageous embodiment of the invention, the support comprises the light source or sources, the source or sources being of the light-emitting diode type and linked to the electrical tracks by a glue filled with metal particles, the glue being preferentially a polymer glue suitable for polymerizing after application. As a variant, the light source or sources can be linked to the electrical tracks by a solder based on tin, copper or other metals.

According to an advantageous embodiment of the invention, the substrate comprises a central portion and a cavity with a bottom and at least one lateral wall, at least one of the zones for receiving light source(s) being on the bottom of the cavity, the connection portion or portions protruding from the central portion in a direction opposite to the cavity. If so desired, at least one of the reception zones can also be arranged on a rear face of the lateral wall.

Advantageously, the light sources, preferably of the LED type, are arranged directly on the substrate and are powered electrically by the electrical tracks extending continuously from the sources to the connection portion.

According to an advantageous embodiment of the invention, the substrate comprises at least one front wall protruding from at least one of the lateral walls, at least one of the electrical tracks extending over the at least one of the front walls and being intended to be linked to the ground in order to form an electromagnetic shielding.

According to an advantageous embodiment of the invention, the support further comprises: a part added onto the substrate, the part comprising an opening intended to receive at least one of the connection portions of the substrate.

According to an advantageous embodiment of the invention, the added part comprises at least one protruding portion supporting a light source of the organic light-emitting diode type.

Also a subject of the invention is a light module, notably for a motor vehicle, comprising: a support for light source(s); at least one optical device suitable for deflecting light rays produced by the light source or sources in order to form at least one light beam; noteworthy in that the support conforms to the invention.

According to an advantageous embodiment of the invention, the optical device or devices is/are supported directly by the substrate.

According to an advantageous embodiment of the invention, at least one of the optical devices comprises a translucent or transparent element forming at least one, preferably two, diopters, the element being a collimator of optical rays in order to form one of the light beams.

According to an advantageous embodiment of the invention, one of the collimators is housed in the cavity of the support.

The provisions of the invention are advantageous in that they make it possible to produce a support with a high level of integration. In effect, the support comprises at least one connection portion of a piece with the rest of the substrate. The electrical tracks can then be deposited directly on the substrate, from the light sources to the portion or portions or vice versa. The substrate can then be molded in a complex form and serve not only as support for light sources but also as support for optical parts and moreover be a visible, and therefore aesthetic, element of a light module.

Other features and advantages of the present invention will be better understood from the description and the drawings in which:

These and other objects and advantages of the invention will be apparent from the following description, the accompanying drawings and the appended claims.

### BRIEF DESCRIPTION OF THE ACCOMPANYING DRAWINGS

FIG. 1 is a perspective view of a light module according to the invention;

FIG. 2 is another perspective view of the light module of FIG. 1;

FIG. 3 is an exploded view of the support for light sources of the module of FIGS. 1 and 2;

FIG. 4 is a view of the rear face of the substrate of the support of FIG. 3;

FIG. 5 is a perspective view of the substrate of FIGS. 3 and 4, and its connector; and

FIG. 6 is a perspective view of the connector of FIG. 5.

### DETAILED DESCRIPTION OF THE PREFERRED EMBODIMENTS

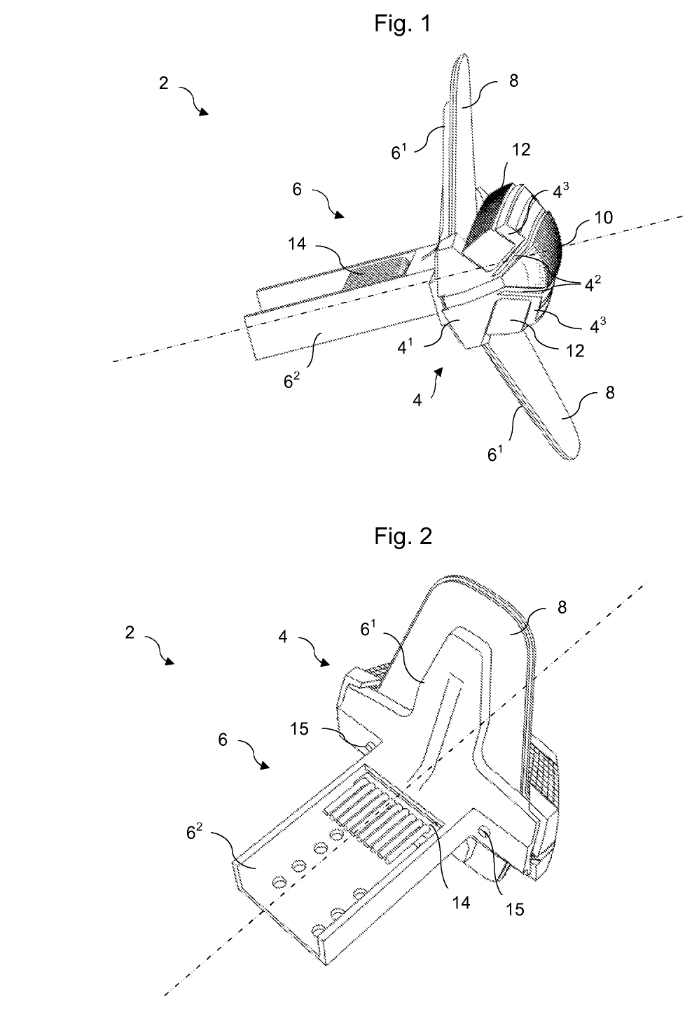

FIGS. 1 and 2 illustrate a light indication module for a motor vehicle. The module 2 is configured to be housed in a housing arranged at the rear of the vehicle. It is configured to ensure a side marker light (or rear light) function, a stop light function and a direction indicator (or flashing) function.

The module 2 comprises a substrate 4 and a part 6 added onto the substrate 4. The added part 6 can be fixed to the substrate 4 by means of the screws 15. The substrate 4 comprises, essentially, a central part 4¹, two lateral walls 4², two front walls 4³ protruding from the lateral walls 4². The two lateral walls 4² form a cavity housing light sources (not visible in FIGS. 1 and 2) and a collimator 10 in order to form a light beam for a direction indicator function.

The added part 6 comprises two supports 6¹ and a rear part 6². The supports 6¹ are arranged in such a way as to protrude from the central part 4¹ of the substrate 4 essentially opposite one another. Each of these supports 6¹ supports a diode of the OLED type 8. An OLED is a light-emitting diode comprising a superposition of a number of organic semiconductor layers between two electrodes, of which (at least) one is transparent. In this case, these OLED diodes 8 ensure a side marker light function. The rear part 6² of the added part 6 is configured to house an electrical power supply connector 14.

The substrate 4 of the module 2 also supports one or more light sources (not visible) between the lateral walls 4² and the OLED diodes 8, this or these light source(s) being covered by a collimator 12 in order to ensure a stop light function. More specifically, the rays emitted by these light sources and deflected by the collimator 12 to meet the front face of the corresponding OLED diode 8 and be reflected there toward the front of the module 2.

The longitudinal axis of the module 2 represented in FIGS. 1 and 2 corresponds to its optical axis. This means that the different light beams produced by the module 2 are oriented essentially along this axis. All these beams are preferentially directed toward the front of the module 2 (corresponding to the right in FIGS. 1 and 2 and to the rear of the vehicle).

The collimators 10 and 12 are parts made of transparent or translucent material, such as glass or polycarbonate (PC) or polymethyl methacrylate (PMMA). They comprise input and/or output surfaces oriented in such a way as to deflect the rays in a main direction, in application of the Snell-Descartes refraction principle. The input and output faces in effect each form a diopter, namely a surface separating two homogeneous and isotropic transparent media, of different refractive indices. The refractive index of air is in effect of the order of 1 whereas that of glass and of polycarbonate lies between approximately 1.4 and 1.6. The principle of operation of a collimator is well known per se to those skilled in the art; there is consequently no need to provide more detail thereof.

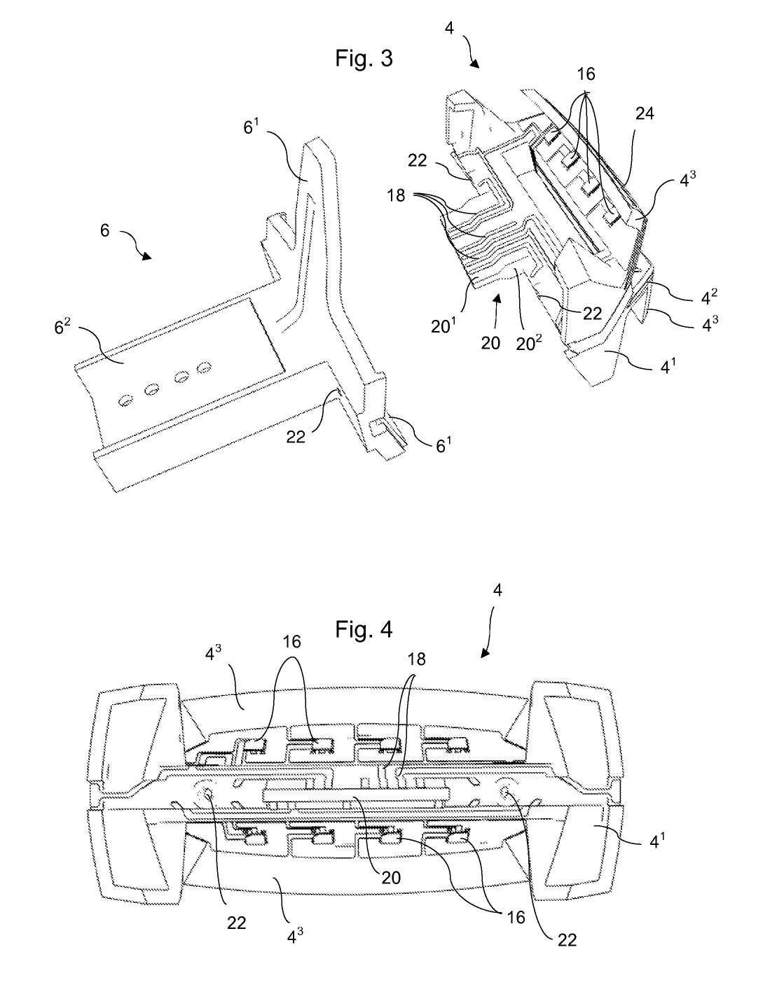

FIG. 3 is an exploded illustration of the support for the light sources of the module 2. The support comprises the substrate 4 and the added part 6. The substrate 4 comprises a portion 20 protruding from its central part 4¹. This portion 20 is intended to cooperate by engagement with the connector 14 (FIGS. 1, 2, 5 and 6) for the electrical power supply of the light sources. Electrical tracks 18 are formed on the surface of the substrate 4, continuously from the light sources to the connection portion 20. FIG. 3 illustrates the light sources 16 of the LED type arranged on the rear face of the upper lateral wall of the two lateral walls 4², it being understood that a similar arrangement is provided on the lower lateral wall of the two lateral walls 4², this arrangement not being visible in FIG. 3. Light sources (not visible), also of the LED type, are also provided between the two lateral walls 4², at the bottom of the cavity formed by the two lateral walls 4². These light sources 16 are also linked electrically by the electrical tracks 18.

The light sources 16, preferentially of the LED type, arranged directly on the substrate 4, are thus powered electrically by the electrical tracks 18 extending continuously from the light sources 16 to the connection portion 20.

The substrate 4, including the connection portion 20, is made of plastic material produced by molding and supports the light sources 16 and the electrical tracks 18, in accordance with the MID (Molded Interconnect Device) technology.

The plastic material of the substrate 4 can be doped with metal particles suitable for ensuring the bonding of the electrical tracks 18 made of metal material on its outer surface.

The electrical tracks 18 can be produced by the technology denoted LDS, standing for Laser Direct Structuring. This involves passing a laser ray over the corresponding surface of the substrate 4, according to the configuration of the electrical tracks 18 to be produced. The laser ray has the effect of forming a roughness suitable for favoring the bonding. This step is followed by a metallization by dipping of the substrate 4 in one or more successive metal baths.

Alternatively, or complementarily, the electrical tracks 18 can be produced by printing of the inkjet type with ink that includes metal particles.

The electrical tracks 18 can also be produced by a two-step molding of the substrate 4, also called “two-shot molding”. This is an injection molding process using two different resins in which just one of the two resins can be metallized. Typically, the metallizable resin is ABS and the non-metallizable resin is polycarbonate. The substrate 4 is then subjected to an autocatalytic deposition process in which butadiene is used to chemically roughen the surface and allow the adhesion of a primary layer of copper.

Because of the thermoplastic nature of the substrate 4, the use of conventional soldering methods for the electrical contacts is not suitable. The LEDs or light sources 16 are thus fixed mechanically and electrically by application of a glue based on polymer and filled with metal elements. It is thus a so-called “cold” application method that does not damage the substrate 4. After polymerization of the glue, the latter ensures the mechanical and electrical fixing of the LED or light source 16.

The connection portion 20 of the substrate 4 is in the form of a generally rectangular tongue. It can have a variable thickness as can be seen in FIG. 3. In effect, it can comprise a distal zone 20¹ relative to the substrate 4, this distal zone 20¹ being intended to penetrate into the connector 14, and a proximal zone 20². The distal zone 20¹ can thus have an average thickness less than that of the proximal zone 20², in this case less than 50% of the average thickness of the proximal zone 20². The transition between these two zones 20¹ and 20² forms a dip. In this case, the dip is present on both main faces of the connection portion 20. The electrical tracks 18 extend essentially parallel to one another and along the main axis of the connection portion 20. In this case, the main axis of the connection portion 20 corresponds to the optical and longitudinal axis of the module 2. The electrical tracks 18 extend essentially to the distal edge of the connection portion 20, so as to extend over all of the distal zone 20¹.

Still referring to FIG. 3, the added part 6 comprises two orifices 22 (just one is visible) intended to receive the screws 15 (FIG. 2) for fixing to the substrate 4. The added part 6 comprises an orifice (not visible) intended to receive the connection portion 20 when the part 6 is assembled with the substrate 4. The added part 6 also comprises, on its rear portion 6², a longitudinal cavity intended to allow the engagement of the connector 14 (FIGS. 1, 2, 5 and 6) with the connection portion 20.

Again referring to FIG. 3, it can be seen that the front walls of the substrate 4 comprise electrical tracks 24 (also visible in FIG. 1), these electrical tracks 24 being directly linked to the power supply tracks for the light sources 16 which are intended to be linked to the ground. These electrical tracks 24 can thus form an electromagnetic shielding, notably for the OLEDs 8 (see FIG. 1) by forming with them a closed electromagnetic field.

FIG. 4 is a view of the rear face of the substrate 4. The connection portion 20 can be observed there, and more particularly the fact that the electrical tracks 18 extend not only over the top face of the connection portion 20 but also over its bottom face. Also to be seen are the light sources 16 on the rear face of the upper lateral wall of the two lateral walls 4² and those on the rear face of the lower lateral wall of the two lateral walls 4². It is also possible to observe the presence of two orifices 22, preferentially threaded, on the rear edge of the central portion 4¹ of the substrate 4, these orifices 22 being intended to receive the screws 15 (FIG. 2) for fixing the part 6 to the substrate 4.

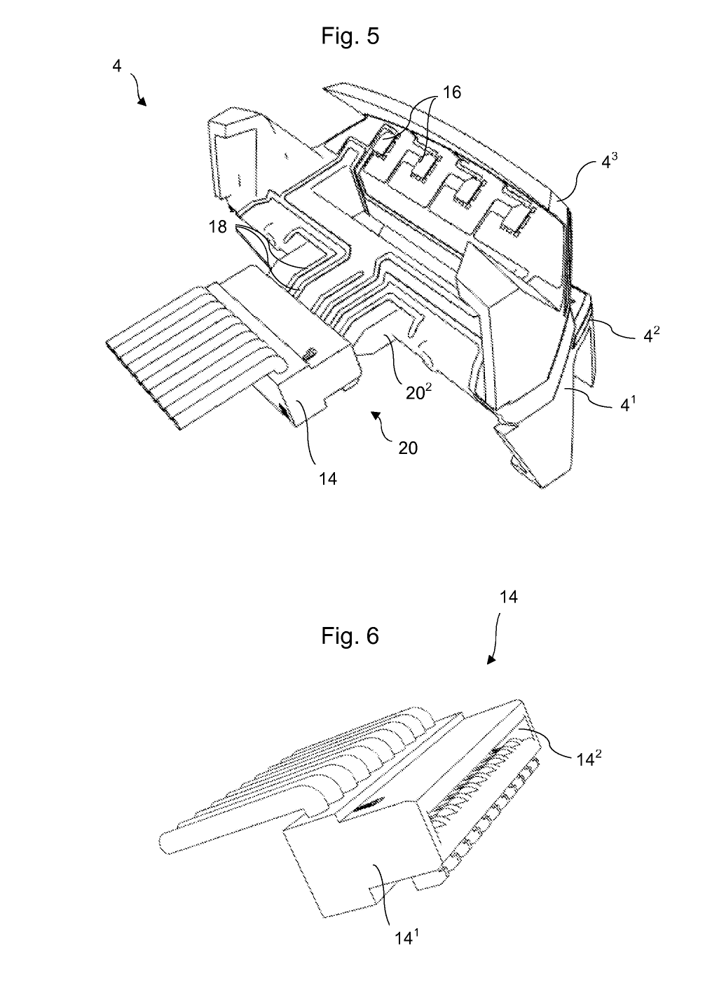

FIG. 5 illustrates the substrate 4 with its connection portion 20 engaged with the connector 14. It can be seen that only the distal portion is engaged with the connector 14, the proximal portion 20² remaining outside of the connector 14.

FIG. 6 illustrates the connector 14 on its own. It essentially comprises a housing 14¹ forming a cavity 14² suitable for receiving the connection portion 20, in the form of a tongue, of the substrate 4. The housing 14¹ comprises, in its cavity 14², a series of elastic metal blades suitable for contacting the electrical tracks 18 on the connection portion 20.

The connection portion 20 can comprise a notch or any other means serving as poka-yoke relative to the direction of the connector 14. The latter can in effect in principle be oriented in two 180° opposing directions, one corresponding to the correct orientation and the other to an orientation 180° from the correct orientation. The notch can be provided on just one of the two sides of the connection portion 20, the notch allowing a corresponding edge of the connector 14 to advance until the connector 14 is in the position of engagement on the connection portion 20. In the case of the opposite orientation, the edge concerned will then abut on a part of the connection portion 20 without any notch, not allowing for the engagement of the connector 14.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A support for light source(s) for a light module, notably for a motor vehicle, comprising:
a substrate with at least one zone or zones for receiving a light source or sources;
electrical tracks deposited on said substrate to said at least one zone or zones for receiving said light source or sources, said electrical tracks being intended to power said light source or sources;
wherein said substrate comprises at least one protruding portion or portions of a piece with the rest of said substrate and on which said light source extend from said at least one zone or zones for receiving said light source, said at least one protruding portion or portions being connection portions suitable for cooperating with an electrical connector, respectively.

2. The support according to claim 1, wherein said substrate is a rigid molded part having a three-dimensional form.

3. The support according to claim 1, wherein said substrate is made of a thermoplastic material doped with metal particles so as to allow the bonding of said electrical tracks made of metal material.

4. The support according to claim 1, wherein at least one of said connection portions has the form of a tongue with two opposing main faces, said electrical tracks extending preferentially on said two opposing main faces.

5. The support according to claim 4, wherein said at least one of said connection portions in the form of a tongue has, on a distal zone intended to penetrate said electrical connector, a reduced thickness relative to the thickness of a proximal zone of said connection portions, the thickness of said distal zone being preferentially less than 50% of the thickness of said proximal zone.

6. The support according to claim 1, wherein at least one of said connection portions comprises a notch serving as poka-yoke with said electrical connector.

7. The support according to claim 1, wherein said support comprises said light source or sources, said light source or sources being of a light-emitting diode type and linked to said electrical tracks by a glue filled with metal particles, said glue being preferentially a polymer glue suitable for polymerizing after application.

8. The support according to claim 1, wherein said substrate comprises a central portion and a cavity with a bottom and at least one lateral wall, at least one zone or zones for receiving said light source being on the bottom of said cavity, said connection portions protruding from said central portion in a direction opposite to said cavity.

9. The support according to claim 8, wherein said substrate comprises at least one front wall protruding from said at least one lateral wall, at least one of said electrical tracks extending over said at least one front wall and being intended to be linked to the ground in order to form an electromagnetic shielding.

10. The support according to claim 1, wherein said support further comprises:
a part added onto said substrate, said added part comprising an opening intended to receive at least one of said connection portions of said substrate.

11. The support according to claim 10, wherein said added part comprises at least one protruding portion supporting said light source of the organic light-emitting diode type.

12. A light module, notably for a motor vehicle, comprising:
a support for light source or sources;
at least one optical device suitable for deflecting light rays produced by said light source or sources in order to form at least one light beam;
wherein said support comprises:
a substrate with at least one zone or zones for receiving said light source or sources,
electrical tracks deposited on said substrate to said at least one zone or zones for receiving said light source or sources, said electrical tracks being intended to power said light source or sources;
wherein said substrate comprises at least one protruding portion or portions of a piece with the rest of said substrate and on which said electrical tracks extend from said at least one zone or zones for receiving said light source, said at least one protruding portion or portions being connection portions suitable for cooperating with an electrical connector, respectively.

13. The light module according to claim 12, wherein said at least one optical device is supported directly by said substrate.

14. The light module according to claim 12, wherein said at least one optical device comprises a translucent or transparent element forming at least one, preferably two, diopters, said translucent or transparent element being a collimator of optical rays in order to form said at least one light beam.

15. The light module according to claim 14, wherein said support comprises said substrate;
wherein said substrate comprises a central portion and a cavity with a bottom and at least one lateral wall, at least one zone or zones for receiving said light source being on the bottom of said cavity, said connection portions protruding from said central portion in a direction opposite to said cavity;
wherein said substrate comprises at least one front wall protruding from said at least one lateral wall, at least one of said electrical tracks extending over said at least one front wall and being intended to be linked to the ground in order to form an electromagnetic shielding, and wherein said collimator is housed in said cavity of said support.

16. The support according to claim 2, wherein said substrate is made of a thermoplastic material doped with metal particles so as to allow the bonding of said electrical tracks made of metal material.

17. The support according to claim 2, wherein at least one of said connection portions has the form of a tongue with two opposing main faces, said electrical tracks extending preferentially on said two opposing main faces.

18. The support according to claim 3, wherein at least one of said connection portions has the form of a tongue with two opposing main faces, said electrical tracks extending preferentially on said two opposing main faces.

19. The light module according to claim 13, wherein said at least one optical device comprises a translucent or transparent element forming at least one, preferably two, diopters, said translucent or transparent element being a collimator of optical rays in order to form said at least one light beam.

20. The support according to claim 2, wherein at least one of said connection portions comprises a notch serving as poka-yoke with said electrical connector.
